(19) United States
(12) Patent Application Publication
(10) Pub. No.: US 2011/0107767 A1
(43) Pub. Date: May 12, 2011

(54) SECONDARY FUEL NOZZLE VENTURI

(75) Inventors: Vaibhav Nadkarni, Bangalore (IN); Swanand Sardeshmukh, West Lafayette, IN (US)

(73) Assignee: General Electric Company, Schnectady, NY (US)

(21) Appl. No.: 12/613,583

(22) Filed: Nov. 6, 2009

(51) Int. Cl. F02C 7/22; F23D 14/62

(52) U.S. Cl. 60/772; 60/737; 431/2; 431/354

(57) ABSTRACT

The present application provides a secondary fuel nozzle assembly for a combustor. The secondary fuel nozzle assembly may include a liner, a fuel passage leading to a pilot burner tip, and a venturi extending from the liner and downstream of the pilot burner tip.

### TECHNICAL FIELD

The present application generally relates to gas turbine engines and more particularly relates to the use of a venturi in a secondary fuel nozzle so to allow for a reduced pilot flow.

### BACKGROUND OF THE INVENTION

Current designs of Dry Low NO_{X} (DLN) gas turbines generally operate with a lean fuel-air mixture. The lean fuel-air mixture includes an amount of fuel premixed with a large amount of excess air that is burned in a combustion chamber. The flame may be stabilized by the combination of a diffusion pilot at the center of a secondary fuel nozzle and the swirl created by a secondary swirler. The diffusion pilot, however, may be a major source of NO_{X} emissions, an emission that is subject to both federal and state regulation in the U.S. and subject to similar regulations abroad. The gas flow to the diffusion pilot, however, generally cannot be reduced without the possibility of flame attachment at the burner tube tip. Flame attachment may have adverse effects on the durability of the burner tube tip and the combustor as a whole such that a minimum predetermined fuel flow generally must be maintained through the diffusion pilot.

There is thus a desire therefore for a reduced pilot fuel flow without the associated flame holding at the burn tube tip and other adverse effects. Such a reduced pilot fuel flow should provide a reduction in NO_{X} emissions as well as promote burner tube durability.

### SUMMARY OF THE INVENTION

The present application thus provides a secondary fuel nozzle assembly for a combustor. The secondary fuel nozzle assembly may include a liner, a fuel passage leading to a pilot burner tip, and a venturi extending from the liner and downstream of the pilot burner tip.

The present application further provides a combustor. The combustor may include a secondary fuel nozzle assembly with a secondary fuel nozzle assembly venturi positioned therein and a secondary combustion chamber positioned downstream of the secondary fuel nozzle assembly with a secondary combustion chamber venturi positioned therein.

The present application further provides a method of reducing flame holding about a secondary nozzle pilot burner tip. The method may include the steps of flowing fuel through the secondary nozzle pilot burner tip, flowing air through a swirler, positioning a venturi downstream of the secondary nozzle pilot burner tip, contracting and expanding the flow of fuel and the flow of air across the venturi, and forming a recirculation zone about the venturi.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a partial cross-sectional view of a known Dry Low NO_{X} combustor.

FIG. 2 is a partial side cross-sectional view of a known combustor center body with an outer swirler.

FIG. 3 is a partial cross-sectional view of a known secondary premixed-diffusion fuel nozzle.

FIG. 4 is a side cut-away view of a fuel nozzle with a secondary venturi as is described herein.

FIG. 5 is a side cross-sectional view of the fuel nozzle with the venturi of FIG. 4 showing a recirculation pattern.

### DETAILED DESCRIPTION

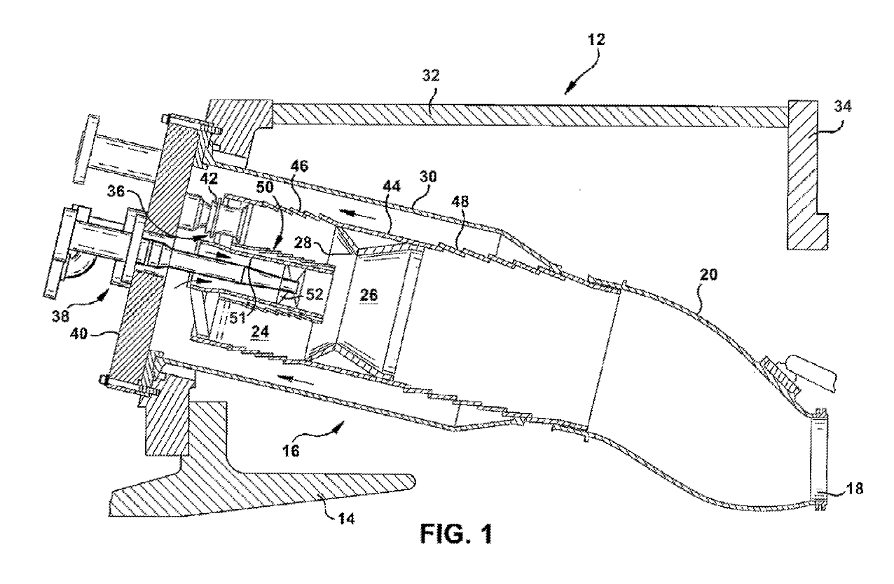

Referring now to the drawings in which like numbers refer to like elements throughout the several views, FIG. 1 shows one example of a known Dry Low NO_{X} gas turbine 12. The gas turbine 12 may include a compressor 14 (partially shown), a number of combustors 16 (one shown for convenience and clarity), and a turbine 18 represented by a single blade. As is known, the compressor 14 pressurizes the inlet air. The compressed air flows to the combustor 16 where it is used to cool the combustor 16 and for the combustion process. Any number of combustors 16 may be used herein. A transition duct 20 connects the outlet end of each combustor 16 with the inlet end of the turbine 18 so as to deliver the hot combustion gases. Other configurations may be used herein.

Each combustor 16 may include a primary or upstream combustion chamber 24 and a secondary or downstream combustion chamber 26. The chambers 24, 26 may be separated by a venturi 28. The venturi 28 is an area of reduced diameter just upstream of the secondary or downstream combustion chamber 26. The venturi 28 increases the velocity of the combustion gases while reducing the pressure therein generally according to Bernoulli's principle. The combustor 16 may be surrounded by a combustor flow sleeve 30. The flow sleeve 30 channels discharged airflow from the compressor 14. The combustor 16 further may be surrounded by an outer casing 32 that is bolted to a turbine casing 34.

A number of primary nozzles 36 may provide fuel to the upstream combustion chamber 24. The primary nozzles 36 may be arranged in an angular array around a central secondary nozzle 38. Each of primary nozzles 36 may protrude into the primary combustion chamber 24 through a rear wall 40. The secondary nozzle 38 may extend from the rear wall 40 so as to introduce fuel into the secondary combustion chamber 26. Fuel may be delivered to the primary nozzles 36 and the secondary nozzle 38 through fuel lines in a manner known in the art. Other nozzle 36, 38 may be used herein.

By way of example, combustion air may be introduced into the primary nozzles 36 through a number of air swirlers 42. The air swirlers 42 may be positioned adjacent to the outlet ends of the nozzles 36. The swirlers 42 introduce swirling combustion air that mixes with fuel from the nozzles 36 so as to provide an ignitable mixture. Combustion air for the swirlers 42 may be derived from the compressor 14 via the flow sleeve 30 and a combustor outer wall 44. The wall 44 of the combustor 16 may be provided with slots or louvers 46 about the primary combustion chamber 24. Similar slots or louvers 48 may be positioned about or downstream of the secondary combustion chamber 26. The slots or louvers 46, 48 may provide air for cooling purposes and to provide dilution air into the combustion zones 24, 26 so as to prevent spikes in flame temperature.

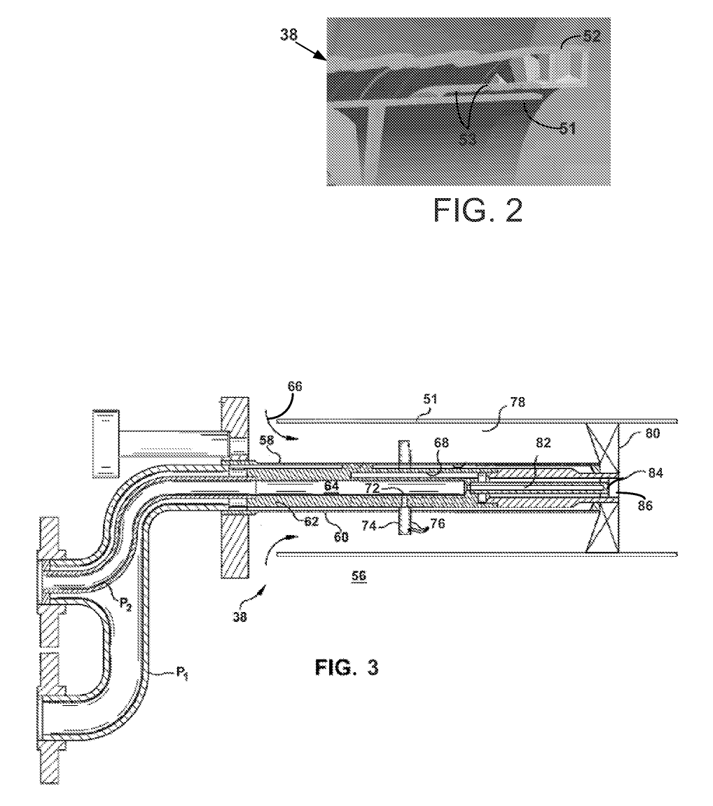

The secondary nozzle 38 may be located within a center body 50 and may include a liner 51 surrounded by an outer swirler 52 as is shown in FIG. 2. The outer swirler 52 may include a number of impingement cooling holes 53 so as to cool the liner 51. Referring again to FIG. 1, a secondary swirler 54 also may be positioned within the secondary nozzle 38. Similar to the swirlers 42 described above, the combustion air passes through the secondary swirler 54 in the secondary nozzle 38 before mixing with fuel.

Referring now to FIG. 3, one example of a gas only secondary fuel nozzle assembly 56 is shown. Fuel may be supplied to sustain a flame by a diffusion pipe P₁ and to sustain a premix flame by pipe P₂. The pipes P₁, P₂ may be arranged concentrically relative to each other. A rearward component or gas body 58 may include an outer sleeve portion 60 and an inner hollow, core portion 62 so as to form a premix fuel passage 64 therein. A number of axial air passages 66 may be formed in the rearward component 58 about the premix passage 64. A like number of radial wall portions may be arrange about the end of the sleeve portion 60. The radial wall portions may have a number of inclined radial apertures for permitting air within the liner 52 to enter a corresponding air passage 68. The rearward end of the component 58 may be adapted to receive the fuel pipes P₁, P₂.

A number of radial holes 72 may be provided about the circumference of the forward portion of the component 58. The radial holes 72 may permit a like number of gas pegs 74 to be received therein so as to establish communication with the premix fuel passage 64. Each peg 74 may be provided with a number of apertures or orifices 76 so to allow fuel from the premix fuel passage 64 to be discharged into a premixing area 78. The premixing area 78 may be positioned between the outer sleeve 60 and the liner 51. The pegs 74 distribute fuel into the airflow such that good mixing of the fuel and air in the premixing area 78 may minimize NO_{X} emissions. A flame holding swirler 80 may be located at the forward end of the secondary nozzle 56 so as to swirl the premixed fuel and air flowing within the liner 51.

In use, fuel may flow through the premix passage 64, a pilot bore 82, and a pilot orifice 84 to a pilot burner tip 86. This fuel, along with air from the swirler 80, may provide a diffusion flame pilot. At the same time, the majority of the fuel supplied to the premix fuel passage 64 may flow into the pegs 74 for discharge from the orifices 76 towards the liner 51 so as to be mixed with air and ignited. Other designs, configurations, and methods may be used with the secondary fuel nozzle assembly 56 and similar components.

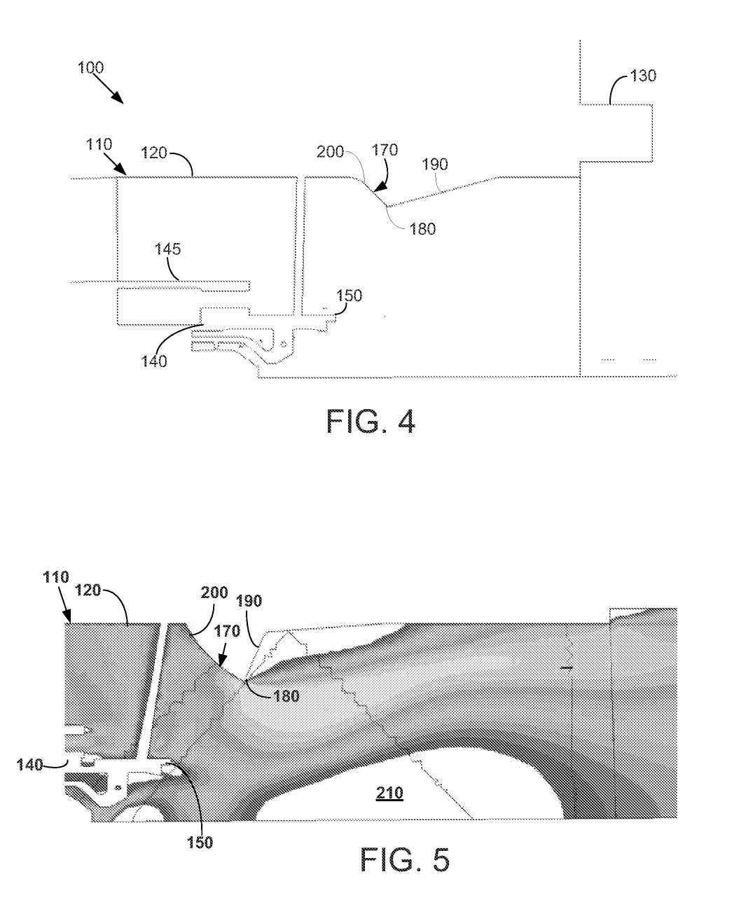

FIG. 4 shows a combustor 100 as may be described herein. The combustor 100 may include a secondary fuel nozzle assembly 110. Similar to the secondary fuel nozzle assembly 56 described above, the secondary fuel nozzle assembly 110 may include a liner 120 leading to an outer swirler 130. Positioned within the liner 120 may be a number of fuel passages 140 enclosed in an outer sleeve 145 in a manner similar to that described above. Several of the fuel passages 140 may extend to a pilot burner tip 150 and otherwise. The pilot burner tip 150 may be surrounded by a secondary swirler 160 as is described above. Air may flow through the secondary swirler 160 so as to mix with the flow of fuel. Many other types of secondary nozzle configurations may be used herein.

A secondary fuel nozzle venturi 170 may, be positioned within the liner 120 and downstream of the pilot burner tip 150 and the secondary swirler 160. The venturi 170 may have a sharp throat edge 180, an abrupt expansion 190, and a front face 200. The front face 200 of the venturi 170 may have an angle of more than about thirty degrees (30°) so as to accelerate the flow therethrough. The sharp throat edge 180 may control the starting point of a central recirculation zone 210 as further described below. Other shapes may be used herein.

The venturi 170 thus forces the fuel air flow within the secondary fuel nozzle assembly 110 to contract and expand as the flow passes along the front face 20, the sharp throat edge 180, and the abrupt expansion 190 thereof. As is shown in FIG. 5, this forced contraction and expansion may create the center recirculation bubble 210 at about the throat 180 of the venturi 170 as the flow accelerates and the pressure is reduced. The bubble 210 may help stabilize the flame away from the pilot burner tip 150 even with a reduced pilot fuel flow therethrough. By way of example, the pilot fuel flow may be reduced by about 0.1 to about 0.3 percent or so. The reduction may depend upon the configuration of the overall secondary nozzle assembly 110 and the components therein.

Such a reduced pilot fuel flow may lead to reduced NOₓ emissions. Further, a low velocity zone behind the venturi 170 may increase the residence time at the burner tip 150, thus possibly reducing carbon monoxide (CO) emissions as well and possibly improving primary-gas secondary interaction. The use of the venturi 170 thus may improve overall combustor stability and turndown. The venturi 170 also may provide flashback resistance about the pilot burner tube tip 150. The use of the venturi 170 thus allows for a reduced pilot fuel flow rate while avoiding flame holding about the pilot burner tube tip 150.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A secondary fuel nozzle assembly for a combustor, comprising:
a liner;
a fuel passage leading to a pilot burner tip; and
a venturi extending from the liner downstream of the pilot burner tip.

2. The secondary fuel nozzle assembly of claim 1, wherein the venturi comprises a throat edge leading to an expansion.

3. The secondary fuel nozzle assembly of claim 1, wherein the venturi comprises a front face.

4. The secondary fuel nozzle assembly of claim 3, wherein the front face comprises an angle of more than about thirty degrees (30°).

5. The secondary fuel nozzle assembly of claim 1, further comprising a secondary swirler positioned about the pilot burner tip.

6. The secondary fuel nozzle assembly of claim 1, further comprising an outer swirler positioned downstream of the venturi.

7. The secondary fuel nozzle assembly of claim 1, further comprising a recirculation zone positioned about the venturi and within the liner.

8. A combustor, comprising:
a secondary fuel nozzle assembly;
the secondary fuel nozzle assembly comprising a secondary fuel nozzle assembly venturi positioned therein;
a secondary combustion chamber positioned downstream of the secondary fuel nozzle assembly; and
the secondary combustion chamber comprising a secondary combustion chamber venturi positioned therein.

9. The combustor of claim 8, wherein the secondary fuel nozzle assembly comprises a liner and a fuel passage leading to a pilot burner tip.

10. The combustor of claim 9, wherein the secondary combustion chamber venturi extends from the liner downstream of the pilot burner tip.

11. The combustor of claim 9, wherein the secondary fuel nozzle assembly comprises a secondary swirler positioned about the pilot burner tip and upstream of the secondary combustion chamber venturi.

12. The combustor of claim 8, wherein the secondary fuel nozzle assembly comprises an outer swirler positioned downstream of the secondary combustion chamber venturi.

13. The combustor of claim 8, wherein the secondary combustion chamber venturi comprises a throat edge leading to an expansion.

14. The combustor of claim 8, wherein the secondary combustion chamber venturi comprises a front face.

15. The combustor of claim 14, wherein the front face comprises an angle of more than about thirty degrees (30°).

16. The combustor of claim 8, further comprising a recirculation zone positioned within the secondary fuel nozzle assembly.

17. A method of reducing flame holding about a secondary nozzle pilot burner tip, comprising:
flowing fuel through the secondary nozzle pilot burner tip;
flowing air through a swirler;
positioning a venturi downstream of the secondary nozzle pilot burner tip;
contracting and expanding the flow of fuel and the flow of air across the venturi; and
forming a recirculation zone about the venturi.

18. The method of claim 17, further comprising the step of reducing the flow of fuel through the secondary nozzle pilot burner tip.

19. The method of claim 18, wherein the step of reducing the flow of fuel through the secondary nozzle burner tip comprises reducing the flow by about 0.1 to about 0.3 percent.

20. The method of claim 18, wherein the step of reducing the flow of fuel through the secondary nozzle burner tip comprises reducing the flow without increasing nitrogen oxide emissions.
